(19) United States
(12) Patent Application Publication
(10) Pub. No.: US 2016/0152082 A1
(43) Pub. Date: Jun. 2, 2016

(54) HIGH ELONGATION STEEL CORD AND PNEUMATIC TIRE COMPRISING SAID CORD

(71) Applicant: NV BEKAERT SA, Zwevegem (BE)

(72) Inventors: He WANG, Jiangyin (CN); Roel DESPIEGELAERE, Marke (BE); Hongzhen ZHU, Jiangyin City (CN)

(73) Assignee: NV BEKAERT SA, Zwevegem (BE)

(21) Appl. No.: 14/902,999

(22) PCT Filed: Jul. 18, 2014
(86) PCT No.: PCT/EP2014/065541

§ 371 Date: Jan. 5, 2016

(30) Foreign Application Priority Data
Aug. 1, 2013 (CN) 201310330114.8
Aug. 1, 2013 (CN) 201320465533.8

(51) Int. Cl. B60C 9/20; B60C 9/02; B60C 9/00; D07B 1/06; D02G 3/48

(52) U.S. Cl. CPC B60C 9/2006; D07B 1/062; D02G 3/48; B60C 9/0007; B60C 9/02; B60C 2009/0092; B60C 2009/0071; B60C 2009/2096; B60C 2009/2093

(57) ABSTRACT

A steel cord having a plurality of strands twisted together with a cord twist pitch. Each strand having a plurality of filaments twisted together with a strand twist pitch. The elongation at break of the steel cord is no less than 5%. The strand having a strand twist angle. The steel cord having a cord twist angle. When the sum of the strand twist angle and the cord twist angle is between 20 and 29 degree, the structural elongation of the steel cord is no less than 2.0%. When the sum of the strand twist angle and the cord twist angle is between 30 and 38 degree, the structural elongation of the steel cord is no less than 2.5%. When the sum of the strand twist angle and the cord twist angle is between 39 and 48 degree, the structural elongation of the steel cord is no less than 3.0%.

### TECHNICAL FIELD

The invention relates to a steel cord, and a pneumatic tire comprising the steel cord.

### BACKGROUND ART

It is generally known to reinforce rubber products with steel cord, especially for pneumatic tires. The “high elongation” steel cord, as a steel cord, is generally used to reinforce zero degree belt or protection layer of pneumatic tires. Said “high elongation” steel cord refers to steel cord with elongation at break no less than 5%. Elongation at break (δ) is an index of the elasticity of the material. Elongation at break is the percentage ratio between the total elongation ΔL and the original length L of the specimen. δ=ΔL/L×100%. The elongation at break comprises the structural elongation of the steel cord. For example, when a high elongation steel cord is stretched, the extension of the steel cord is firstly the structural elongation. When the steel cord is further stretched, the steel cord may break and result in the elongation at break.

In the tire making process, especially the making of tire with zero degree belt reinforced with high elongation steel cord, high elongation steel cord with high structural elongation is required, otherwise the steel cord may not extent to the right position during the tire lifting process. For now, the commonly used high elongation steel cord 3×7×0.20 mm, is the reinforcement for zero degree belt for tire. This structure has a comparatively big strand twist angle and cord twist angle (20.37/20.84 degree), to achieve a comparatively high structural elongation and elongation at break (2.25%/7.17%). But this structure faces the problem for rubber penetration, wherein the steel cord cannot be embedded in the rubber matrix properly, and eventually corrosion occurs and limits the life time of pneumatic tire. Therefore, there is a need to seek a high elongation steel cord with high structural elongation and full rubber penetration.

Besides, in the manufacturing process for special pneumatic tires, for example, the super single tire, the zero degree belt of super single tire is only reinforced by one layer of winded steel cord, which requires high elongation steel cord with extra structural elongation to extent to the right position in the tire lifting process. The commonly used high elongation steel cord 3×7×0.20 mm with structural elongation (2.25%) cannot meet this requirement. Further increase the strand twist angle and cord twist angle to achieve extra structural elongation, will lead to a fragile cord. Even the cord may hold some load, the other mechanical properties of the steel cord, for example, fatigue, breaking load are limited, which cuts the life time of the steel cord. Therefore, there is a need to seek a high elongation steel cord with high structural elongation, for example more than 3.0% structural elongation, while maintaining the small strand twist angle and cord twist angle.

### DISCLOSURE OF INVENTION

The primary object of the invention is to provide a high elongation steel cord with high structural elongation and full rubber penetration.

The other object of the invention is to provide a pneumatic tire comprising that high elongation steel cord with high structural elongation and full rubber penetration.

According to an aspect of the invention, the steel cord comprises a plurality of strands twisted together with a cord twist pitch. Each strand comprises a plurality of filaments twisted together with a strand twist pitch. The elongation at break of the steel cord is no less than 5%. The strand comprises a strand twist angle. The steel cord comprises a cord twist angle. When the sum of the strand twist angle and the cord twist angle is between 20 and 29 degree, the structural elongation of the steel cord is no less than 2.0%. When the sum of the strand twist angle and the cord twist angle is between 30 and 38 degree, the structural elongation of the steel cord is no less than 2.5%. When the sum of the strand twist angle and the cord twist angle is between 39 and 48 degree, the structural elongation of the steel cord is no less than 3.0%.

Preferably, the structural elongation of the steel cord is no more than 4.0%.

The formula to calculate the strand twist angle and cord twist angle is

$$α = arctan \frac{π d}{Ls * sin \frac{180 °}{n}} ,$$

wherein α is the strand twist angle, d the filament diameter, Ls the strand twist pitch, n the number of filaments in the strand.

$$β = arctan \frac{π d ( 1 + sin \frac{180 °}{n} )}{Lc * sin \frac{180 °}{m} * sin \frac{180 °}{n}}$$

wherein β is the cord twist angle, d the filament diameter, Lc the cord twist pitch, m the number of strands in the cord, n the number of filament in the strand.

For now, the commonly used high elongation steel cord can be made according following approaches, increasing the twist pitch of the steel cord, or increasing the filament diameter, or increasing the number of strands. In a word, according to above formula, increasing the twist angle of the steel cord may provide high elongation steel cord. But the twist angle of the steel cord cannot be increased unlimitedly, and there are limits to increase the twist angle of the steel cord. Further increase the strand twist angle and cord twist angle, will eventually result in a fragile cord. Even the cord may hold some load, the other mechanical properties of the steel cord, for example, fatigue, breaking load are limited, which cuts the life time of the steel cord.

Different from the prior art, present invention provides another approach to achieve high elongation steel cord. The structure of steel cord is more open, the gaps between filaments and strands are bigger, and the elongation at break and structural elongation are higher (with the same twist angle). Because the gaps are bigger, rubber penetration is improved, to meet the requirement on rubber penetration.

According to present invention, the number of strands may preferably between 2 and 7, and the number of filaments in the strand may preferably between 2 and 9.

Besides, the strand can be formed by the steel filament in a single layer structure, i.e. the n×1 structure, or a double layer structure. For example, the strand is a double layer structure, i.e. (m)+n structure, wherein (m) filaments forms the core and n filaments forms the layer surrounding the core. The filament in the core can be parallel without twist (i.e. twist pitch more than 300 mm), for example, a strand structure (2)+2. Said twist pitch means the axial distance required to make a 360 degree revolution of steel filament around the axis of the strand or strand around the axis of the cord.

Since the steel cord according to present invention is used for pneumatic tires, the filament diameter of the steel cord can be any parameter known to the technical personal in this field. Preferably, filament diameter may range between 0.10 mm and 0.60 mm, for example, 0.14 mm, 0.26 mm, and 0.38 mm.

According to present invention, the metal filament is a steel filament. The steel composition may contain a minimum carbon content of 0.65% and small amount of manganese, silicon, sulphur, phosphorus and so on. For example, comprising 0.70% carbon, 0.50% manganese, 0.202% silicon, 0.013% sulphur, and 0.085% phosphorus, all percentages being percentage by weight. Specifically, high carbon steel filament may have a carbon content about 0.80%, for example, 0.78-1.02% carbon, 0.30%-1.10% manganese, 0.15%-1.30% silicon, less than 0.15% sulphur, and less than 0.02% phosphorus, all percentages being percentage by weight. Further, the steel composition may contain other metal alloy ingredients, for example, 0.20%-0.40% chromium, 0.20% copper, and 0.30% vanadium, all percentages being percentage by weight.

According to present invention, the metal filament may be coated, and preferably with zinc coating or brass coating. The thickness of the coating can be any parameter known to the technical personals in this field, for example, brass coating with thickness 0.2 micrometer.

According to one of the best embodiments of present invention, the steel cord comprises three strands, each strand comprises four steel filaments, filament diameter is 0.24 mm, the strand twist angle is 13.62 degree, the cord twist angle is 14.72 degree, the sum of the two twist angles is 28.34 degree, the structural elongation of the steel cord is 2.42%, and the elongation at break of the steel cord is 6.19%.

According to one of the best embodiments of present invention, the steel cord comprises three strands, each strand comprises four steel filaments, filament diameter is 0.26 mm, the strand twist angle is 14.71 degree, the cord twist angle is 15.89 degree, the sum of the two twist angles is 30.6 degree, the structural elongation of the steel cord is 2.99%, and the elongation at break of the steel cord is 7.14%.

According to one of the best embodiments of present invention, the steel cord comprise three strands, each strand comprises four steel filaments, filament diameter is 0.26 mm, the strand twist angle is 16.11 degree, the cord twist angle is 15.89 degree, the sum of the two twist angles is 32 degree, the structural elongation of the steel cord is 3.28%, and the elongation at break of the steel cord is 7.92%.

The steel cord has extra structural elongation, which is suitable to reinforce the zero degree belt for the super single tire with one layer of winded steel cord. To the contrary, prior art increase the twist angles of the steel cord to provide a steel cord with extra structural elongation, for example structural elongation more than 3%. But the twist angle of the steel cord cannot be increased unlimitedly, and there are limits to increase the twist angle of the steel cord. Further increasing the strand twist angle and cord twist angle, will eventually result in a fragile cord. Even the cord may hold some load, the other mechanical properties of the steel cord, for example, fatigue, breaking load may deteriorate.

According to one of the best embodiments of present invention, the steel cord comprises four strands, each strand comprises four steel filaments, filament diameter is 0.22 mm, the strand twist angle is 12.52 degree, the cord twist angle is 16.43 degree, the sum of the two twist angles is 28.95 degree, the structural elongation of the steel cord is 2.97%, and the elongation at break of the steel cord is 6.69%.

According to the other aspect of present invention, a pneumatic tire comprises carcass, belt, zero degree belt and crown. The zero degree belt comprises steel cord and rubber matrix where the steel cord embedded. The steel cord comprises a plurality of strands twisted together with a cord twist pitch. Each strand comprises a plurality of filaments twisted together with a strand twist pitch. The elongation at break of the steel cord is no less than 5%. The strand comprises a strand twist angle. The steel cord comprises a cord twist angle. When the sum of the strand twist angle and the cord twist angle is between 20 and 29 degree, the structural elongation of the steel cord is no less than 2.0%. When the sum of the strand twist angle and the cord twist angle is between 30 and 38 degree, the structural elongation of the steel cord is no less than 2.5%. When the sum of the strand twist angle and the cord twist angle is between 39 and 48 degree, the structural elongation of the steel cord is no less than 3.0%. Preferably, the structural elongation of the steel cord is no more than 4.0%.

According to another aspect of present invention, a pneumatic tire comprises carcass, belt and crown. The belt comprises transition layer, working layer and protection layer. The protection layer comprises steel cord and rubber matrix where the steel cord embedded. The steel cord comprises a plurality of strands twisted together with a cord twist pitch. Each strand comprises a plurality of filaments twisted together with a strand twist pitch. The elongation at break of the steel cord is no less than 5%. The strand comprises a strand twist angle. The steel cord comprises a cord twist angle. When the sum of the strand twist angle and the cord twist angle is between 20 and 29 degree, the structural elongation of the steel cord is no less than 2.0%. When the sum of the strand twist angle and the cord twist angle is between 30 and 38 degree, the structural elongation of the steel cord is no less than 2.5%. When the sum of the strand twist angle and the cord twist angle is between 39 and 48 degree, the structural elongation of the steel cord is no less than 3.0%. Preferably, the structural elongation of the steel cord is no more than 4.0%.

As disclosed above, “twist pitch” twist pitch means the axial distance required to make a 360 degree revolution of steel filament around the axis of the strand or strand around the axis of the cord.

### BRIEF DESCRIPTION OF FIGURES IN THE DRAWINGS

FIG. 1 schematically illustrates the method to determine the structural elongation and elongation at break of steel cord incorporating present invention.

FIG. 2 schematically illustrates the cross-sectional view of a 3×4 steel cord incorporating present invention.

FIG. 3 is the front view of a plurality of steel cord in parallel incorporating present invention.

FIG. 4a schematically illustrates the manufacturing process for a steel cord according to prior arts.

FIG. 4b schematically illustrates the manufacturing process for a steel cord incorporating present invention.

FIG. 5 schematically illustrates the cross-sectional view of a 4×4 steel cord incorporating present invention.

FIG. 6a is the cross-sectional view of a 3×4 steel cord incorporating present invention with rubber penetration.

FIG. 6b is the cross-sectional view of a 3×4 steel cord according to prior arts with rubber penetration.

### MODE(S) FOR CARRYING OUT THE INVENTION

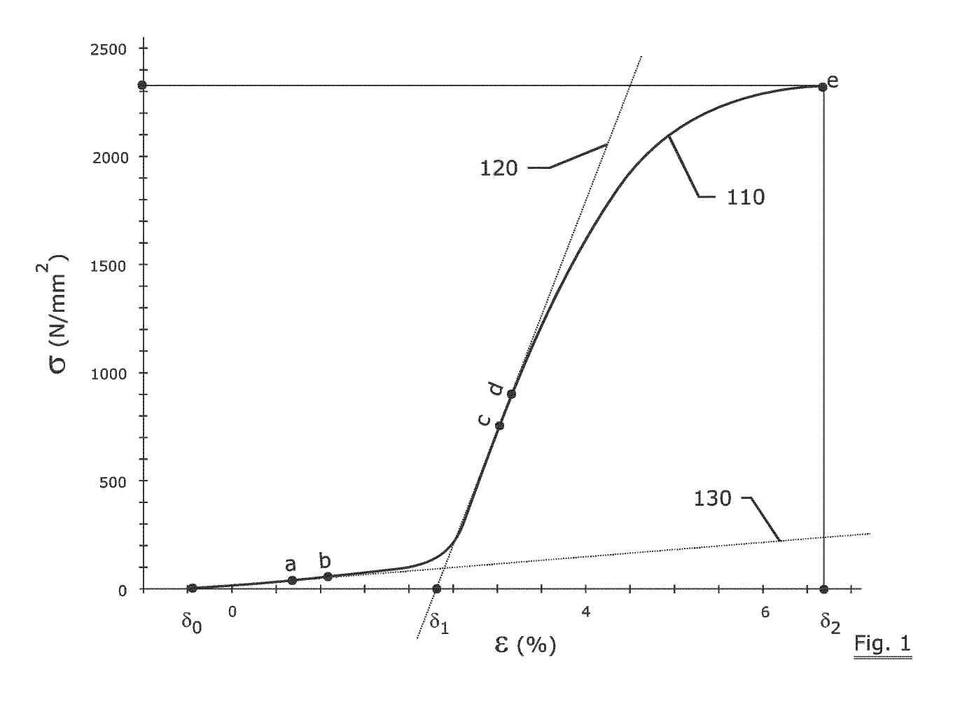

FIG. 1 schematically illustrates the method to determine the structural elongation and elongation at break of steel cord incorporating present invention. In FIG. 1, curve 110 is the tensile-elongation curve of the steel cord. As shown by curve 110, the steel cord firstly goes through the structural elongation phase and further enters into the elastic deformation phase. 120 is the elasticity modulus line, i.e. line 120 connects two points c, d at the elastic phase on curve 110. The point of intersection between line 120 and the abscissa axis is δ1. 130 is the structural elongation regression line, i.e. line 130 connects two points a, b at the structural elongation phase on curve 110. The point of intersection between line 130 and the abscissa axis is δ0. The sum of |δ1| and |δ0| is the structural elongation of the steel cord. The break point e, the end point of curve 110, of the steel cord, has an orthographic projection point δ2 on the abscissa axis, while |δ2| is the elongation at break of the steel cord.

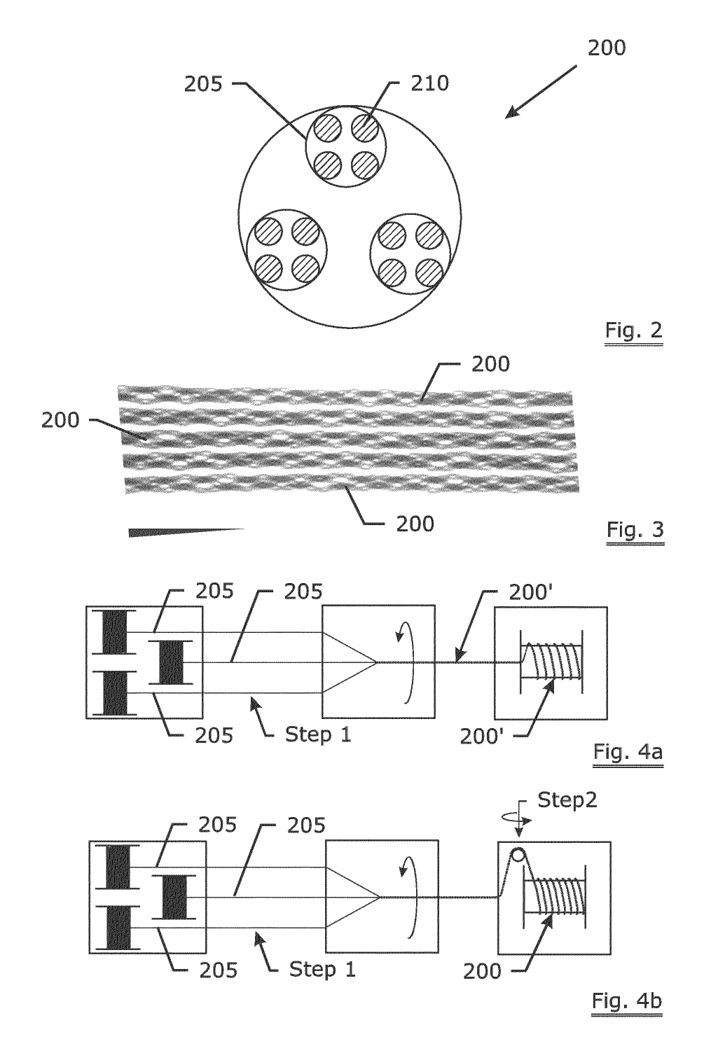

FIG. 2 schematically illustrates the cross-sectional view of a 3×4 steel cord incorporating present invention. FIG. 3 is the front view of a plurality of steel cord in parallel incorporating present invention. As shown in FIG. 2, steel cord 200 is a 3×4 structure. The steel cord comprises three strands 205 twisted together, and each strand 250 comprise four steel filaments 210 twisted together. The steel filament diameter is 0.24 mm. The strand twist angle is 13.62 degree, and the cord twist angle is 14.72 degree. The sum of the two twist angles is 28.34 degree.

The prior art steel cord 200′ can be manufactured according to following step. Firstly the four steel filaments 210 are twisted together to form the strand 205, and then the three strands 205 are twisted together according to the step shown in FIG. 4a to form the prior art steel cord 200′, wherein the twist pitch is 8 mm, i.e. 125 twists in one meter length. In the first embodiment of present invention, steel strands 205 are twisted together according to the two steps shown in FIG. 4b. The first step is to twist the three steel strand 205 together with the twist pitch 5.33 mm, i.e. 187.5 twists in one meter length. The second step is to give reverse twist at the take-up station to increase the twist pitch to 8 mm, i.e. reverse twist 62.5 rounds in one meter length to achieve the final twist 125 rounds in one meter length. The steel cord 200 incorporating present invention has a strand twist angle 13.62 degree, a cord twist angle 14.72 degree, and the sum of the two twist angles is 28.34 degree (as shown by FIG. 2).

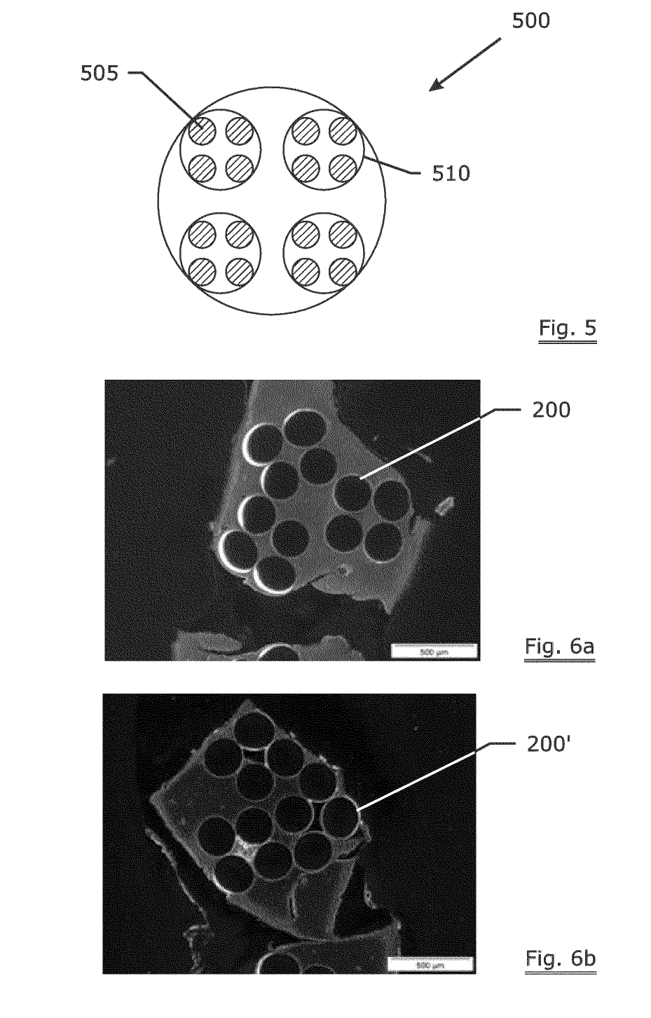

FIG. 5 schematically illustrates the cross-sectional view of a 4×4 steel cord of the second embodiment. The steel cord 500 is a 4×4 structure. The steel cord comprises four steel strands 510 twisted together, and each steel strand 510 comprise four steel filaments 505 twisted together. The diameter of filament 505 is 0.26 mm. The strand twist angle is 14.71 degree, the cord twist angle is 15.89 degree, and the sum of the two twist angles is 30.6 degree.

Below table 1 shows the comparison test between the embodiments and prior arts.

| | 3 × 4 (prior | 3 × 4 | 4 × 4 (prior | 4 × 4 |
|---|---|---|---|---|
| | art) | (invention) | art) | (invention) |
| Strand/cord | 4.4/8 | 4.4/8 | 4.4/8 | 4.4/8 |
| twist pitch | | | | |
| (mm) | | | | |
| Strand twist | 13.62 | 13.62 | 12.52 | 12.52 |
| angle | | | | |
| (degree) | | | | |
| Cord twist | 14.72 | 14.72 | 16.43 | 16.43 |
| angle | | | | |
| (degree) | | | | |
| Elongation at | 4.45 | 6.19 | 4.78 | 6.69 |
| break (%) | | | | |
| Structural | 1.35 | 2.42 | 1.38 | 2.97 |
| elongation | | | | |
| (%) | | | | |
| Air pressure | 70 | 0 | 55 | 0 |
| drop (%) | | | | |

As shown in table 1, with the same strand twist angle and cord twist angle, steel cord incorporating present invention has a higher structural elongation and elongation at breaked compared with prior arts, which can avoid the belt seperation problem in the tire making process. Besides, the rubber penetration is also improved. The lower air pressure drop the better rubber penetration. Air pressure drop 0% means full rubber penetration. The test method for air pressure drop is disclosed by CN102666972A. As shown by FIGS. 6a and 6b, present invention steel cord 200 achieves full rubber penetration, while prior art steel cord 200′ has limited rubber penetration, wherein corrsion may occur inside the strand. Present invention steel cord has an open structure to allow full rubber penetration not only between the strands but also inside the strands, to avoid corrosion on the filaments, which further improved the lifetime of the steel cord for the reinforcement of pneumatic tires, especially for the reinforcement of zero degree belt of pneumatic tires.

Besides, one prior art steel cord 3×4×0.24 may has the same steel cord structure and comparable structural elongation as present invention, but the mechanical properties are different as shown in below table 2.

| | | Present invention | Prior art |
|---|---|---|---|
| Twist pitch/mm | strand | 4.4 | 3 |
| | cord | 8 | 6 |
| Twist angle/ | Strand | 13.62 | 19.57 |
| degree | cord | 14.72 | 19.31 |

| | | |
|---|---|---|
| Breaking load/N | 1508 | 1351 |
| Structural elongation % | 2.42 | 2.35 |
| Elongation at break % | 6.19 | 7.57 |
| Air pressure drop % | 0 | 90 |
| Linear density | 4.67 | 4.89 |
| Belt ply weight % (same strength) | 100 | 107 |
| Belt ply cost % (same strength | 100 | 106 |

Table 2 shows that prior art steel cord may achieve similar structural elongation, but prior art steel cord requires big strand twist angle and cord twist angle, which undercut the breaking load of the steel cord. While present invention steel cord has smaller strand twist angle and cord twist angle with lower linear density to provide a lighter belt ply with low cost. Pneumatic tire reinforced by present invention steel cord not only requires less material but also brings lower rolling resistance.

As the third embodiment of present invention, the 5×2 steel cord comprises 5 strands and each strand comprises 2 steel filaments. The filament diameter is 0.26 mm. The strand twist angle is 10.52 degree, the cord twist angle is 19.16 degree, and the sum of the two twist angles is 29.68 degree. The elongation at break of the steel cord is 6.27%, and the structural elongation of the steel cord is 2.78%.

While the invention is illustrated and described by above embodiments, it is not intended to be limited to the details shown. Modifications and changes that may be made without departing in any way from the spirit of present invention, are in the protection scope of present invention.

1-7. (canceled)

8. A steel cord, comprising a plurality of strands twisted together with a cord twist pitch, said each strand comprising a plurality of filaments twisted together with a strand twist pitch, the elongation at break of said steel cord is no less than 5%, said strand comprising a strand twist angle, said steel cord comprising a cord twist angle, wherein when the sum of said strand twist angle and said cord twist angle is between 20 and 29 degree, the structural elongation of said steel cord is no less than 2.0%, when the sum of said strand twist angle and said cord twist angle is between 30 and 38 degree, the structural elongation of said steel cord is no less than 2.5%, when the sum of said strand twist angle and said cord twist angle is between 39 and 48 degree, the structural elongation of said steel cord is no less than 3.0%.

9. A steel cord according to claim 8, wherein the structural elongation of said steel cord is no more than 4.0%.

10. A steel cord according to claim 9, wherein the number of said strand is between 2 and 7, the number of said filaments in the strand is between 2 and 9.

11. A steel cord according to claim 8, wherein the diameter of the said filament is between 0.10 mm and 0.60 mm.

12. A steel cord according to claim 8, wherein the filaments in the strand are constructed in a single layer or double layer structure.

13. A pneumatic tire, comprising carcass, belt, zero degree belt and crown, wherein said zero degree belt comprises steel cord according to claim 8 and the rubber matrix where the steel cord embedded.

14. A pneumatic tire, comprising carcass, belt and crown, said belt comprising transition layer, working layer and protection layer, wherein said protection layer comprises steel cord according to claim 8 and the rubber matrix where the steel cord embedded.
